(19) United States
(12) Patent Application Publication
(10) Pub. No.: US 2026/0201965 A1
(43) Pub. Date: Jul. 16, 2026

(54) VALVE ASSEMBLY

(71) Applicants: Hanon Systems, Daejeon (KR); HANON SYSTEMS EFP KOREA INC., Asan-si Chungcheongnam-do (KR)

(72) Inventors: Oh Sang Shin, Asan-si Chungcheongnam-do (KR); Jeong Wan Han, Daejeon (KR)

(21) Appl. No.: 19/135,201

(22) PCT Filed: Oct. 31, 2023
(86) PCT No.: PCT/KR2023/017178

§ 371 Date: Jun. 3, 2025

(30) Foreign Application Priority Data
Dec. 7, 2022 (KR) 10-2022-0170019

(51) Int. Cl. F16K 11/085

(52) U.S. Cl. CPC F16K 11/0853

(57) ABSTRACT

A valve assembly in which a plurality of ports are disposed at the same height in a cylinder instead of being disposed in multiple layers, positions of first and second flow paths based on an axial direction of the cylinder overlap each other, and a cross-sectional area of the flow path is constant from one end to the other end of the flow path, such that a plurality of flow paths may be formed compactly in one cylinder, and a pressure loss may be minimized.

### CROSS REFERENCE TO RELATED PATENT APPLICATIONS

This is a U.S. national phase patent application of PCT/KR 2023/017178 filed Oct. 31, 2023, which claims the benefit of and priority to Korean Patent Application No. 10-2022-0170019 filed on Dec. 7, 2022, the entire contents of each of which are incorporated herein by reference for all purposes.

### TECHNICAL FIELD

The present invention relates to a valve assembly, and more particularly, to a valve assembly in which a plurality of ports are disposed at the same height in a cylinder instead of being disposed in multiple layers, positions of first and second flow paths based on an axial direction of the cylinder overlap each other, and a cross-sectional area of the flow path is constant from one end to the other end of the flow path, such that a plurality of flow paths may be formed compactly in one cylinder, and a pressure loss may be minimized.

### BACKGROUND ART

A valve assembly refers to a device installed in flow paths, through which a fluid flows, and configured to control a flow direction of the fluid. The valve assembly has a structure in which a cylinder, which has therein a plurality of flow paths through which the fluid passes, is inserted into a housing and opens or closes the flow paths by being rotated by a manipulation of a handle or a motor.

A valve assembly generally used in a vehicle is a valve having passageways for a fluid configured in three directions, and the valve assembly is an automatic control valve manually combined with a control motor and configured to adjust a flow rate while switching flow paths for the fluid.

For example, the typical three-way valve assembly may be installed by means of a compressor, a heater core, and the flow paths and configured to adjust a temperature of a vehicle interior by controlling a flow of a coolant having circulated through an engine of the vehicle to introduce the coolant into a heater core or allow the coolant to bypass the heater core (two modes).

However, the three-way valve has a limitation in coping with a complicated mode of an electric vehicle that is provided in addition to the two modes. In addition, in case that the number of passageways for the fluid is increased and a larger number of flow paths are formed in the cylinder in order to cope with the complicated mode, there is a problem in that a size of the cylinder needs to be excessively increased, and the cylinders need to be stacked in multiple layers.

### SUMMARY

An object of the present invention is to provide a valve assembly in which a plurality of ports are disposed at the same height in a cylinder instead of being disposed in multiple layers, positions of first and second flow paths based on an axial direction of the cylinder overlap each other, and a cross-sectional area of the flow path is constant from one end to the other end of the flow path, such that a plurality of flow paths may be formed compactly in one cylinder, and a pressure loss may be minimized.

Technical problems to be solved by the present invention are not limited to the above-mentioned technical problems, and other technical problems, which are not mentioned above, may be clearly understood from the following descriptions by those skilled in the art to which the present invention pertains.

In order to achieve the above-mentioned object, one embodiment of the present invention provides a valve assembly including: a cylinder having a plurality of ports provided in a lateral surface thereof, the cylinder having at least one first flow path configured to connect two ports among the plurality of ports and opened in one axial direction, and at least one second flow path configured to connect two ports among the other ports and opened in the other axial direction; a first plate coupled to the cylinder in one axial direction and configured to close at least one first flow path; and a second plate coupled to the cylinder in the other axial direction and configured to close at least one second flow path, in which a position of at least one first flow path and a position of at least one second flow path based on the axial direction of the cylinder overlap each other.

According to the embodiment, the plurality of ports may be aligned at the same height of the cylinder.

According to the embodiment, two opposite ends of at least one first flow path connected to the two ports may be formed to be closer to the second plate than a middle portion of at least one first flow path, and two opposite ends of at least one second flow path connected to another two ports may be formed to be closer to the first plate than a middle portion of at least one second flow path.

According to the embodiment, the ports may be provided as twelve ports, the first flow path may be provided as three first flow paths, and the second flow path may be provided as three second flow paths.

According to the embodiment, all the three first flow paths may be curved flow paths each configured to connect two ports with one port interposed therebetween.

According to the embodiment, one of the three second flow path may be a straight flow path configured to connect two ports that face each other, and the remaining two second flow paths may be curved flow paths each configured to connect two ports with one port interposed therebetween.

According to the embodiment, a cross-sectional area of each of at least one first flow path and at least one second flow path may be constant from one end to the other end.

According to the embodiment, the first plate may include a plurality of first protruding portions protruding toward two opposite ends of at least one first flow path.

According to the embodiment, the second plate may include a plurality of second protruding portions protruding toward two opposite ends of at least one second flow path.

According to the embodiment, the first plate may have at least one first auxiliary flow path groove debossed at a position corresponding to at least one first flow path.

According to the embodiment, the second plate may have at least one second auxiliary flow path groove debossed at a position corresponding to at least one second flow path.

According to the embodiment, the first plate and the second plate may be fixed to the cylinder by welding.

According to the embodiment, a first welding groove may be formed in the cylinder along a periphery of at least one first flow path, and a first welding protrusion may be formed on the first plate and formed in a shape corresponding to the first welding groove.

According to the embodiment, a second welding groove may be formed in the cylinder along a periphery of at least one second flow path, and a second welding protrusion may be formed on the second plate and formed in a shape corresponding to the second welding groove.

In order to achieve the above-mentioned object, another embodiment of the present invention provides a valve assembly including: a cylinder having a plurality of ports provided in a lateral surface thereof, the cylinder having at least one first flow path configured to connect two ports among the plurality of ports and opened in one axial direction, and at least one second flow path configured to connect two ports among the other ports and opened in the other axial direction; a first plate coupled to the cylinder in one axial direction and configured to close at least one first flow path; and a second plate coupled to the cylinder in the other axial direction and configured to close at least one second flow path, in which the plurality of ports are aligned at the same height of the cylinder.

According to the present invention, the plurality of ports are provided in the cylinder and disposed at the same height without being disposed in multiple layers, and the positions of the first and second flow paths based on the axial direction of the cylinder overlap each other, such that the plurality of flow paths may be compactly formed in one cylinder in order to cope with various modes even without excessively increasing the size of the cylinder or stacking the cylinders.

In addition, with the protruding portions or the auxiliary flow path grooves, the cross-sectional areas of the flow paths are constant from one end to the other end, such that a pressure loss may be minimized.

In addition, because the first plate and the second plate are fixed to the cylinder by welding, the flow paths may be sealed without a separate gasket or bolt, there is no risk of coolant corrosion of a bolt tab and bolt loosening, and the thickness and size of the plate does not increase.

The effects of the present invention are not limited to the above-mentioned effects, and it should be understood that the effects of the present invention include all effects that may be derived from the configuration of the present invention disclosed in the detailed description of the present invention.

### DESCRIPTION OF DRAWINGS

FIG. 1 is an exploded perspective view illustrating a valve assembly according to an embodiment of the present invention when viewed from one side.

FIG. 2 is an exploded perspective view illustrating the valve assembly in FIG. 1 when viewed from another side.

FIGS. 3A and 3B are front and rear views illustrating states in which a cylinder in FIG. 1 is separated.

FIG. 3C is a cross-sectional view taken along line A-A in FIG. 3B.

FIGS. 4A and 4B are rear and side views illustrating states in which a first plate in FIG. 1 is separated.

FIGS. 5A and 5B are front and side views illustrating states in which a second plate in FIG. 1 is separated.

FIG. 6 is a cross-sectional view taken along line A-A in FIG. 3B in a state in which the valve assembly in FIG. 1 is assembled.

FIG. 7 is a cross-sectional view taken along line B-B in FIG. 3A in the state in which the valve assembly in FIG. 1 is assembled.

FIG. 8 is a front perspective view illustrating a second plate according to another embodiment of the present invention.

FIG. 9 is a side view of FIG. 8.

FIGS. 10A to 10D are views illustrating four exemplary modes that operate when the valve assembly in FIG. 1 is applied to a coolant cooling module.

FIGS. 11A to 11D are views illustrating flow velocities of a coolant passing through flow paths in the four modes in FIGS. 10A to 10D.

### DESCRIPTION OF AN EMBODIMENT

Hereinafter, exemplary embodiments of a valve assembly of the present invention will be described with reference to the accompanying drawings.

In addition, the terms used below are defined considering the functions in the present invention and may vary depending on the intention of a user or an operator or a usual practice. The following embodiments are not intended to limit the protection scope of the present invention but just exemplary constituent elements disclosed claims in the present invention.

A part irrelevant to the description will be omitted to clearly describe the present invention, and the same or similar constituent elements will be designated by the same reference numerals throughout the specification. Throughout the specification, unless explicitly described to the contrary, the word “comprise/include” and variations such as “comprises/includes” or “comprising/including” will be understood to imply the inclusion of stated elements, not the exclusion of any other elements.

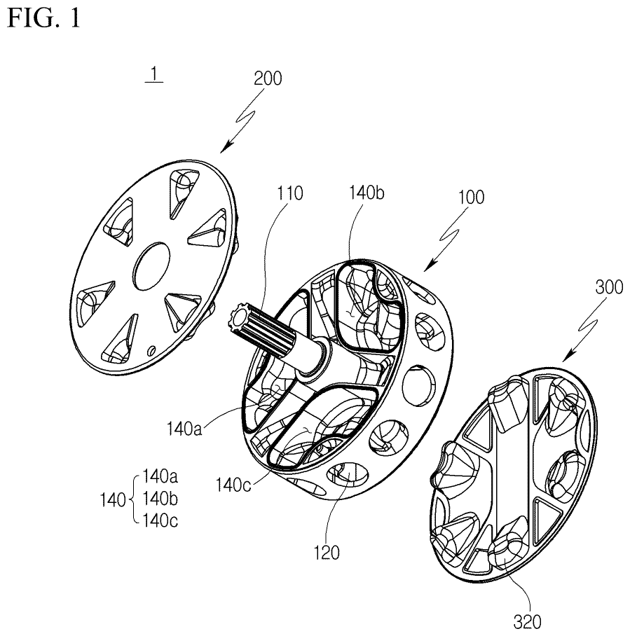

First, a structure of a valve assembly 1 according to an embodiment of the present invention will be described with reference to FIGS. 1 to 7.

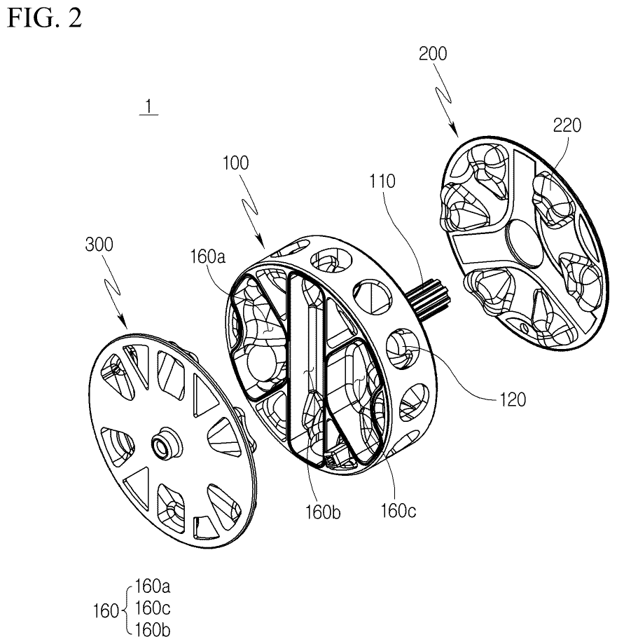

The valve assembly of the present invention broadly includes a cylinder 100, a first plate 200, and a second plate 300. The first plate 200 and the second plate 300 are respectively coupled to two opposite axial ends of the cylinder 100 and define a cylindrical shape as a whole. As illustrated in FIGS. 1 and 2, a configuration will be described below in which the first plate 200 is coupled to an upper side of the cylinder 100, and the second plate 300 is coupled to a lower side of the cylinder 100.

A rotary shaft 110 may be provided at a center of the cylinder 100, such that the cylinder 100 may be rotated by a manipulation of a separate handle or motor. A plurality of ports 120 are provided in a lateral surface of the cylinder 100 and allow the outside and inside of the cylinder 100 to communicate with each other. In the present embodiment, twelve ports 120 are provided. However, the present invention is not limited thereto.

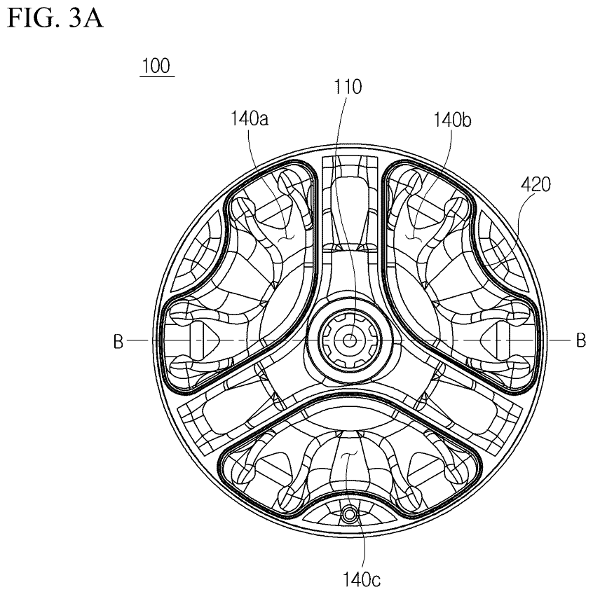

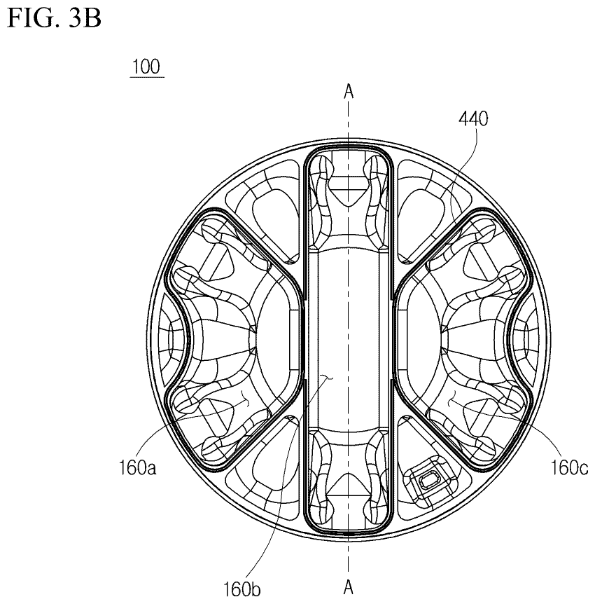

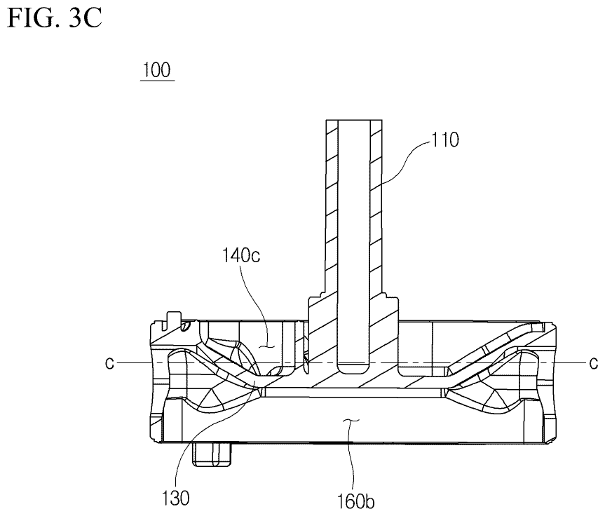

In addition, the cylinder 100 includes at least one first flow path 140 configured to connect two ports among the plurality of ports 120 and opened in one axial direction, i.e., opened upward based on the drawings, and at least one second flow path 160 configured to connect two ports among the other ports 120 and opened in the other axial direction, i.e., opened downward based on the drawings. In this case, as illustrated in FIG. 3C, the first flow path 140 and the second flow path 160 may be separated from each other by a partition wall 130 in the cylinder. That is, the inside of the cylinder 100 is divided into two layers in the axial direction by the partition wall 130, such that the first flow path 140 may be formed in one layer, and the second flow path 160 may be formed in the other layer.

As described above, the first plate 200 is coupled to the upper side of the cylinder 100 and closes the opened side of the first flow path 140, and the second plate 300 is coupled to the lower side of the cylinder 100 and closes the opened side of the second flow path 160. Therefore, the first flow path 140 connects the two ports 120, and two opposite axial sides of the first flow path 140 are closed by the first plate 200 and the partition wall 130. The second flow path 160 also connects the two ports 120, and two opposite axial sides of the second flow path 160 are closed by the partition wall 130 and the second plate 300.

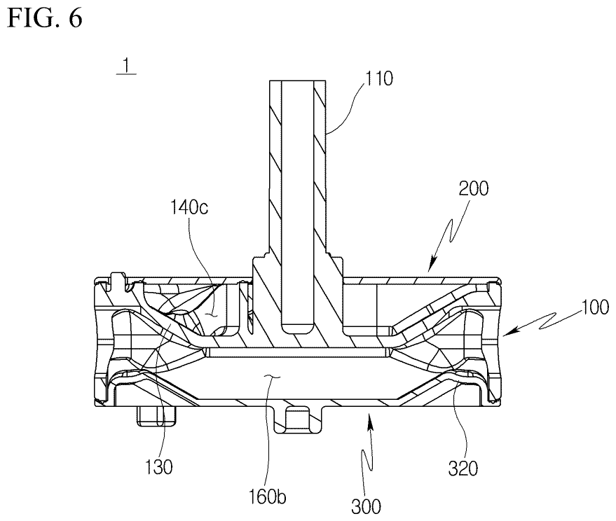

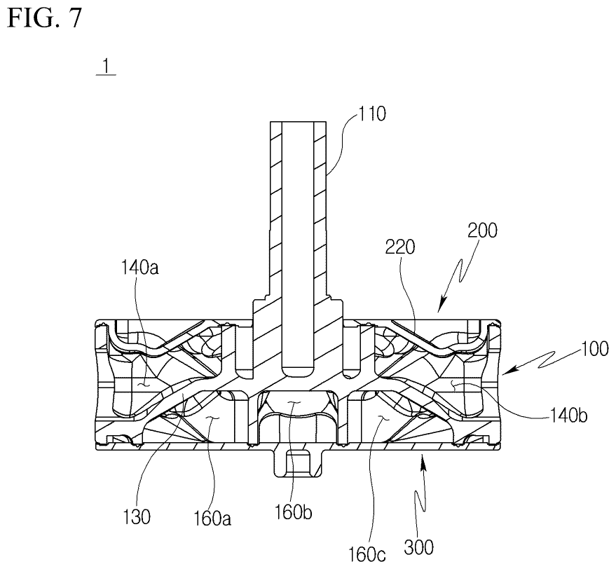

In particular, in the present invention, the positions of the first and second flow paths 140 and 160 based on the axial direction of the cylinder 100 overlap each other. That is, as illustrated in FIGS. 6 and 7, the partition wall 130 has a portion formed to be convex upward or convex downward without being formed flat, such that both the first and second flow paths 140 and 160 are formed at a predetermined height of the cylinder 100. In order to express this configuration, FIG. 3C illustrates line C-C that is perpendicular to the axial direction and simultaneously passes through the first flow path 140 and the second flow path 160. Therefore, the plurality of ports 120 may be aligned at the same height of the cylinder 100 and do not need to be disposed in multiple layers.

Specifically, the two opposite ends of the first flow path 140 connected to the two ports 120 are formed to be closer to the second plate 300 than a middle portion of the first flow path 140. To this end, the partition wall 130 is formed to be convex upward from the two opposite ends of the first flow path 140 to the middle portion of the first flow path 140 (see FIG. 7). In addition, the two opposite ends of the second flow path 160 connected to the two ports 120 are formed to be closer to the first plate 200 than a middle portion of the second flow path 160. To this end, the partition wall 130 is formed to be convex downward from the two opposite ends of the second flow path 160 to the middle portion of the second flow path 160 (see FIG. 6). In this case, when viewed in a circumferential direction of the cylinder 100, a position of one end of the first flow path 140 may correspond to a position of the middle portion of the second flow path 160, and a position of one end of the second flow path 160 may correspond to a position of the middle portion of the first flow path 140.

As described above, the plurality of ports 120 are provided in the cylinder 100 and disposed at the same height without being disposed in multiple layers, and the positions of the first and second flow paths 140 and 160 based on the axial direction of the cylinder 100 overlap each other, such that the plurality of flow paths may be compactly formed in one cylinder 100 in order to cope with various modes even without excessively increasing the size of the cylinder 100 or stacking the cylinders 100.

In the present embodiment, twelve ports 120 are provided, such that three first flow paths 140a, 140b, and 140c and three second flow paths 160a, 160b, and 160c are formed. Specifically, as illustrated in FIGS. 1 and 3A, all the three first flow paths 140a, 140b, and 140c may each be formed as a curved flow path configured to connect two ports 120 with one port interposed therebetween. In addition, as illustrated in FIGS. 2 and 3B, among the three second flow paths 160a, 160b, and 160c, one second flow path 160b may be formed as a straight flow path configured to connect the two ports 120 that face each other, and the remaining two second flow paths 160a and 160c may each be formed as a curved flow path configured to connect the two ports 120 with one port interposed therebetween.

In this case, one end of a first-first flow path 140a corresponds to a middle portion of a second-first flow path 160a, and the other end of the first-first flow path 140a corresponds to a region between the second-first flow path 160a and a second-second flow path 160b. In addition, one end of a first-second flow path 140b corresponds to a region between the second-second flow path 160b and a second-third flow path 160c, and the other end of the first-second flow path 140b corresponds to a middle portion of the second-third flow path 160c. Lastly, one end of a first-third flow path 140c corresponds to a region between the second-third flow path 160c and the second-second flow path 160b, and the other end of the first-third flow path 140c corresponds to a region between the second-second flow path 160b and the second-first flow path 160a.

As illustrated in FIG. 3C, because the partition wall 130 is not formed flat, a cross-sectional area of the second flow path 160 is not constant from one end to the other end, i.e., from an inlet to an outlet when the second plate 300 is not coupled to the cylinder 100. In particular, the cross-sectional area rapidly decreases from one end to the middle portion of the second flow path 160, and the cross-sectional area rapidly increases from the middle portion to the other end. Likewise, when the first plate 200 is not coupled to the cylinder 100, the cross-sectional area of the first flow path 140 is not constant from one end to the other end, i.e., from the inlet to the outlet.

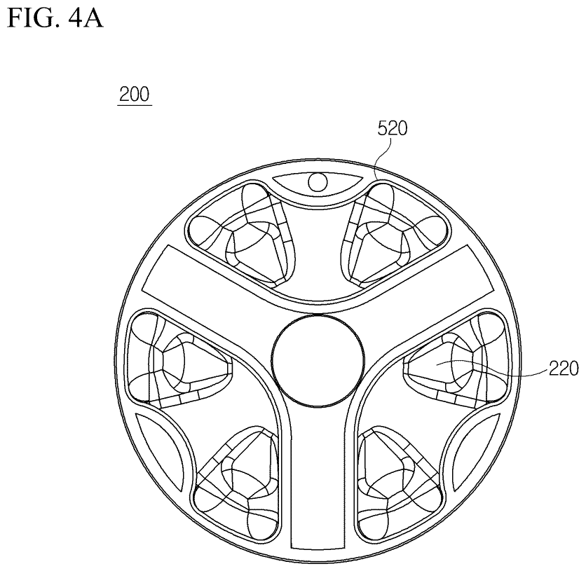

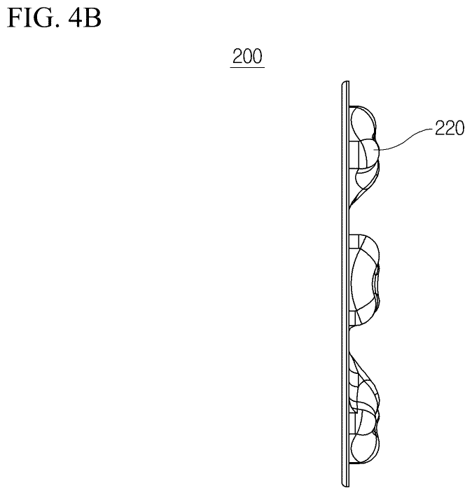

In order to cope with these situations, as illustrated in FIGS. 2, 4A, and 4B, the first plate 200 may include a plurality of first protruding portions 220 protruding toward the two opposite ends of the first flow paths 140. In the present embodiment, because the three first flow paths 140a, 140b, and 140c are formed, six first protruding portions 220 are formed on the first plate 200 while corresponding to the positions of the two opposite ends of the first flow paths.

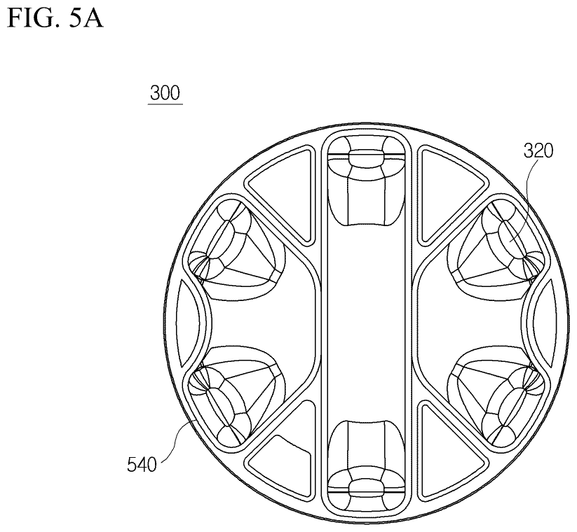

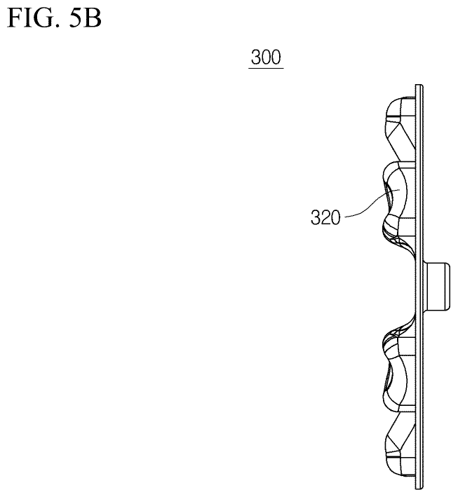

Likewise, as illustrated in FIGS. 1, 5A, and 5B, the second plate 300 may include a plurality of second protruding portions 320 protruding toward the two opposite ends of the second flow paths 160. In the present embodiment, because the three second flow paths 160a, 160b, and 160c are formed, six second protruding portions 320 are formed on the second plate 300 while corresponding to the positions of the two opposite ends of the second flow paths.

Therefore, as illustrated in FIG. 6, when the second plate 300 is coupled to the cylinder 100, the cross-sectional areas of the two opposite ends of the second flow paths 160, which have been comparatively large in FIG. 3C, are decreased by the second protruding portions 320, such that the cross-sectional area of the second flow path 160 may be maintained to be constant from one end to the other end.

Likewise, as illustrated in FIG. 7, when the first plate 200 is coupled to the cylinder 100, the cross-sectional areas of the two opposite ends of the first flow paths 140, which have been comparatively large, are decreased by the first protruding portions 220, such that the cross-sectional area of the first flow path 140 may be maintained to be constant from one end to the other end.

As described above, the cross-sectional areas of the first and second flow paths 140 and 160 are constant from one end to the other end, such that a pressure loss may be minimized.

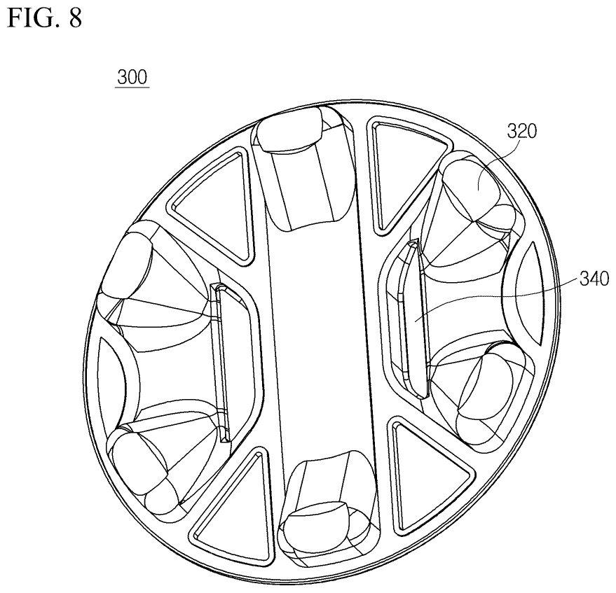

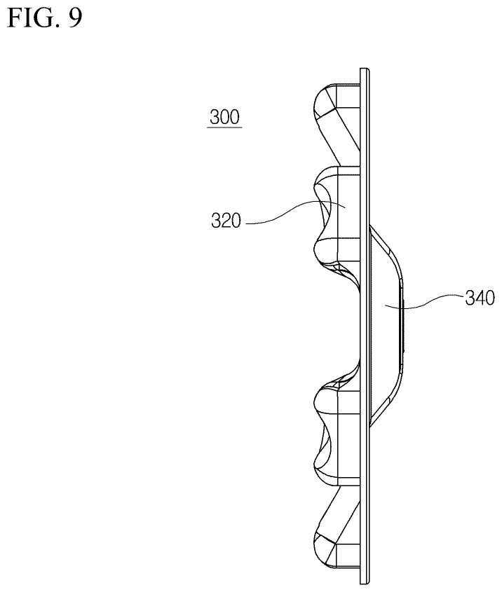

In addition, according to another embodiment in FIGS. 8 and 9, in addition to the second protruding portions 320, the second plate 300 may further include second auxiliary flow path grooves 340 debossed at positions corresponding to the second flow paths 160, particularly, debossed at positions, except for the two opposite ends of the second flow paths 160. However, the present invention is not limited thereto. FIGS. 8 and 9 illustrate that the second auxiliary flow path grooves 340 are respectively formed at positions corresponding to the second-first flow path 160a and the second-third flow path 160c. In particular, the second auxiliary flow path grooves 340 are formed radially inside the second protruding portions 320 provided to correspond to the positions of the two opposite ends of the flow paths 160a and 160c.

Likewise, in addition to the first protruding portion 220, the first plate 200 may further include first auxiliary flow path grooves (not illustrated) debossed at positions corresponding to the first flow paths 140, particularly, debossed at positions, except for the two opposite ends of the first flow paths 140.

Therefore, when the second plate 300 is coupled to the cylinder 100, the cross-sectional areas of the two opposite ends of the second flow paths 160, which have been comparatively large, are decreased by the second protruding portions 320, and the cross-sectional areas are increased by the second auxiliary flow path grooves 340 in the region excluding the two opposite ends of the second flow paths 160 that have been comparatively small in cross-sectional areas, such that the cross-sectional area of the second flow path 160 may be maintained to be constant from one end to the other end. In particular, the cross-sectional area of the second flow path 160 may be maintained to be large in comparison with the case in which the second plate 300 includes only the second protruding portion 320. That is, in case that the second plate 300 includes the second auxiliary flow path groove 340, a height of the second protruding portion 320 may be somewhat decreased.

In addition, when the first plate 200 is coupled to the cylinder 100, the cross-sectional areas of the two opposite ends of the first flow paths 140, which have been comparatively large, are decreased by the first protruding portions 220, and the cross-sectional areas are increased by the first auxiliary flow path grooves (not illustrated) in the region excluding the two opposite ends of the first flow paths 140 that have been comparatively small in cross-sectional areas, such that the cross-sectional area of the first flow path 140 may be maintained to be constant from one end to the other end. Likewise, the cross-sectional area of the first flow path 140 may be maintained to be large in comparison with the case in which the first plate 200 includes only the first protruding portion 220.

However, the present invention is not limited thereto. The first plate 200 may, of course, include only the first auxiliary flow path groove without including the first protruding portion 220, and the second plate 300 may, of course, include only the second auxiliary flow path groove 340 without including the second protruding portion 320.

In the present invention, the first plate 200 and the second plate 300 may be fixed to the cylinder 100 by welding. Various methods, such as ultrasonic welding, vibration welding, or thermal welding, may be used as the welding.

In order to implement more effective welding, first welding grooves 420 may be formed at an upper side of the cylinder 100 and formed along peripheries of the first flow paths 140a, 140b, and 140c, and first welding protrusions 520 may be formed on a lower surface of the first plate 200 while corresponding to the first welding grooves 420. In addition, second welding grooves 440 may be formed at a lower side of the cylinder 100 and formed along peripheries of the second flow paths 160a, 160b, and 160c, and second welding protrusions 540 may be formed on an upper surface of the second plate 300 while corresponding to the second welding grooves 440.

As described above, because the first plate 200 and the second plate 300 are fixed to the cylinder 100 by welding, the flow paths may be sealed without a separate gasket or bolt, there is no risk of coolant corrosion of a bolt tab and bolt loosening, and the thickness and size of the plate does not increase.

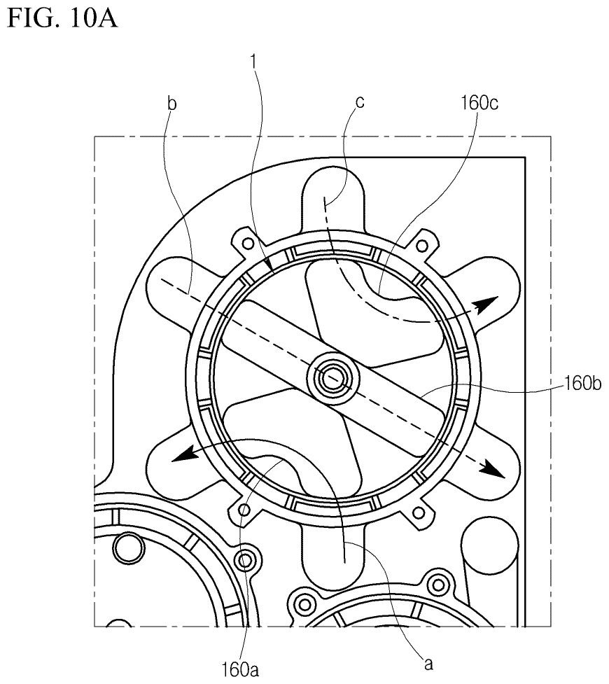

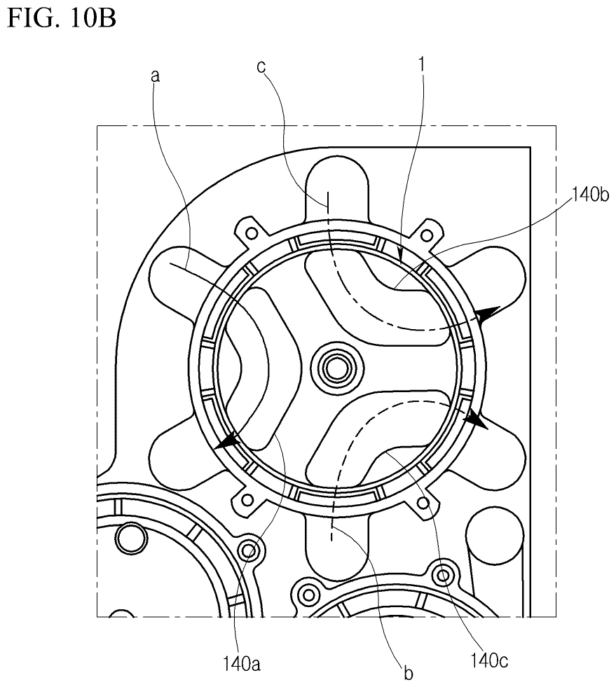

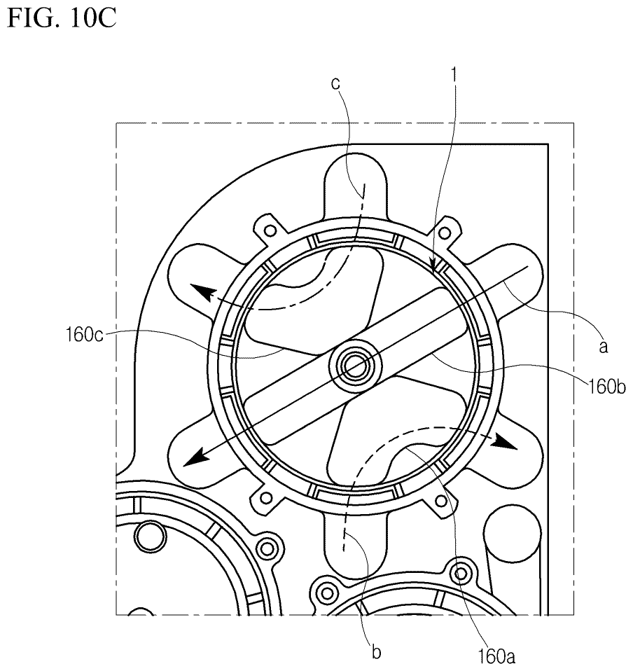

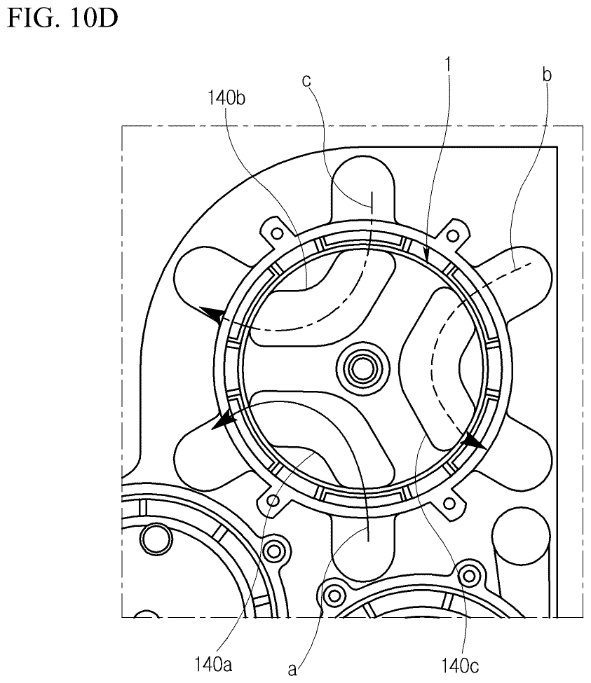

Next, four exemplary modes operating when the valve assembly 1 of the present invention is coupled to a coolant control module (CCM) will be described with reference to FIGS. 10A to 10D. For example, the solid arrow (a) may correspond to a coolant flow path connected to a battery of an electric vehicle to cool the battery, the dotted arrow (b) may correspond to a coolant flow path connected to a motor of the electric vehicle to cool the motor, and the one-dot chain arrow (c) may correspond to a coolant flow path connected to a radiator. For convenience, FIGS. 10A to 10D illustrate only the coolant flow paths through which the coolant flows in the modes.

In a first mode in FIG. 10A, the coolant flows through the three second flow paths 160a, 160 b, and 160 c. In a second mode in FIG. 10B, the valve assembly 1 rotates by 30° counterclockwise in comparison with the first mode, such that the coolant flows through the three first flow paths 140a, 140b, and 140c. In addition, in a third mode in FIG. 10C, the valve assembly 1 rotates by 30° counterclockwise in comparison with the second mode, such that the coolant flows through the three second flow paths 160a, 160b, and 160c again. In a fourth mode in FIG. 10D, the valve assembly 1 rotates by 30° counterclockwise in comparison with the third mode, such that the coolant flows through the three first flow paths 140a, 140b, and 140c again.

As described above, a plurality of ports (particularly, eight or twelve ports) are provided in the cylinder 100, and the plurality of flow paths, which each connect the two ports in the cylinder 100, overlap one another in the axial direction and are formed compactly, such that it is possible to cope with various modes (particularly, four or five modes) of the electric vehicle.

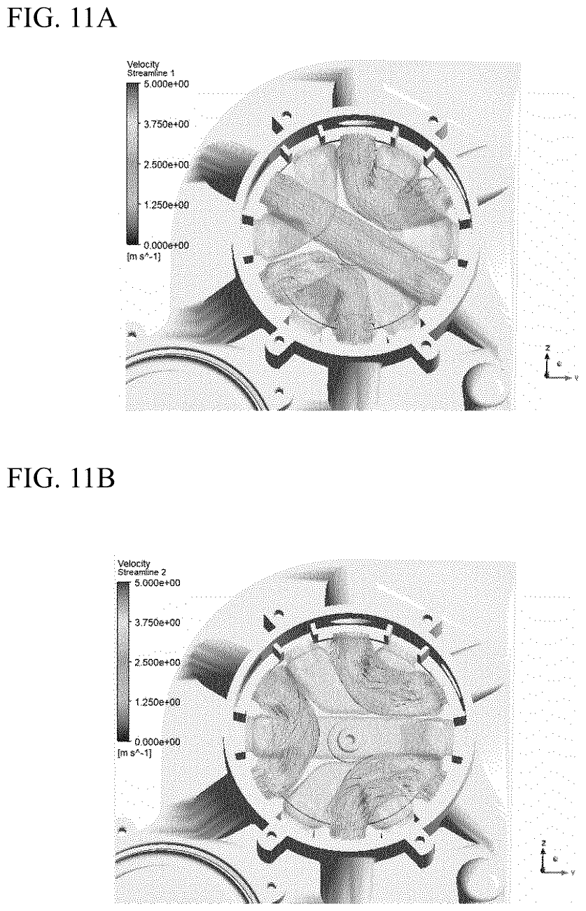

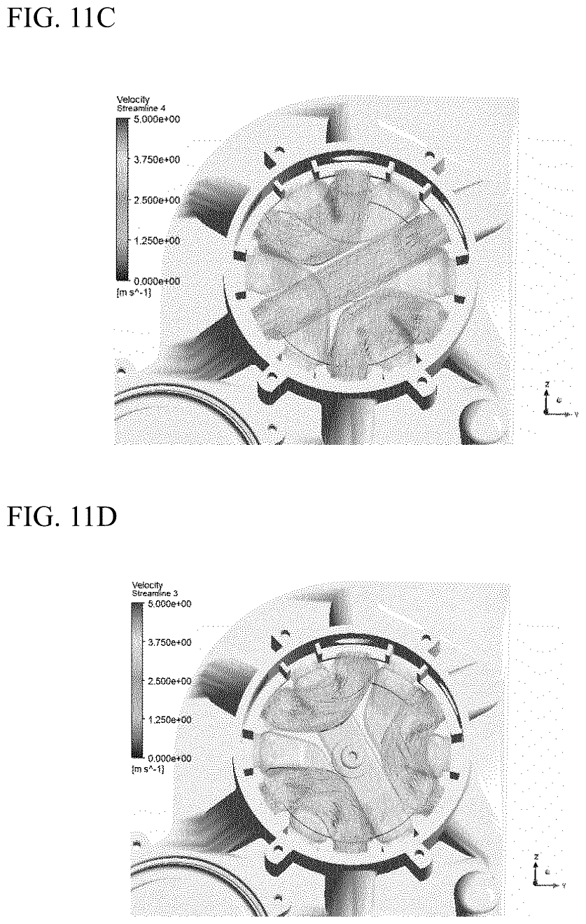

FIGS. 11A to 11D illustrate flow velocities of the coolant passing through the flow paths in the four modes in FIGS. 10A to 10D.

The flow velocities of the coolant passing through the first flow paths 140 and the second flow paths 160 are uniform from the inlets to the outlets along the flow paths. That is, as described above, the cross-sectional areas of the first and second flow paths 140 and 160 are constant from one end to the other end, such that a pressure loss is minimized.

The present invention is not limited to the specific exemplary embodiments and descriptions, various modifications can be made by any person skilled in the art to which the present invention pertains without departing from the subject matter of the present invention as claimed in the claims, and the modifications are within the protection scope of the present invention.

The present invention relates to a valve assembly in which a plurality of ports are disposed at the same height in a cylinder instead of being disposed in multiple layers, positions of first and second flow paths based on an axial direction of the cylinder overlap each other, and a cross-sectional area of the flow path is constant from one end to the other end of the flow path, such that a plurality of flow paths may be formed compactly in one cylinder, and a pressure loss may be minimized.

1-15. (canceled)

16. A valve assembly comprising:
a cylinder having a plurality of ports provided in a lateral surface thereof, the cylinder having at least one first flow path configured to connect a first pair of ports among the plurality of ports and opened in a first axial direction, and at least one second flow path configured to connect a second pair of ports among the plurality of ports and opened in a second axial direction;
a first plate coupled to the cylinder in the first axial direction and configured to close the at least one first flow path; and
a second plate coupled to the cylinder in the second axial direction and configured to close the at least one second flow path, wherein a position of the at least one first flow path and a position of the at least one second flow path based on a central axis of the cylinder overlap each other.

17. The valve assembly of claim 16, wherein the plurality of ports is aligned at a same height of the cylinder.

18. The valve assembly of claim 16, wherein two opposite ends of the at least one first flow path connected to the first pair of ports are formed to be closer to the second plate than a middle portion of the at least one first flow path, and two opposite ends of the at least one second flow path connected to the second pair of ports are formed to be closer to the first plate than a middle portion of the at least one second flow path.

19. The valve assembly of claim 18, wherein the plurality of ports is provided as twelve ports, the at least one first flow path is provided as three first flow paths, and the at least one second flow path is provided as three second flow paths.

20. The valve assembly of claim 19, wherein all the three first flow paths are curved flow paths each configured to connect the first pair of ports with one of the plurality of ports interposed therebetween.

21. The valve assembly of claim 19, wherein one of the three second flow paths is a straight flow path configured to connect the second pair of ports that face each other, and two of the three second flow paths remaining are curved flow paths each configured to connect a third pair of ports with one port interposed therebetween.

22. The valve assembly of claim 18, wherein a cross-sectional area of each of the at least one first flow path and the at least one second flow path is constant from a first end to a second end.

23. The valve assembly of claim 18, wherein the first plate further comprises a plurality of first protruding portions protruding toward two opposite ends of the at least one first flow path.

24. The valve assembly of claim 18, wherein the second plate further comprises a plurality of second protruding portions protruding toward two opposite ends of the at least one second flow path.

25. The valve assembly of claim 18, wherein the first plate has at least one first auxiliary flow path groove debossed at a position corresponding to the at least one first flow path.

26. The valve assembly of claim 18, wherein the second plate has at least one second auxiliary flow path groove debossed at a position corresponding to the at least one second flow path.

27. The valve assembly of claim 16, wherein the first plate and the second plate are fixed to the cylinder by welding.

28. The valve assembly of claim 27, wherein a first welding groove is formed in the cylinder along a periphery of the at least one first flow path, and a first welding protrusion is formed on the first plate and formed in a shape corresponding to the first welding groove.

29. The valve assembly of claim 27, wherein a second welding groove is formed in the cylinder along a periphery of the at least one second flow path, and a second welding protrusion is formed on the second plate and formed in a shape corresponding to the second welding groove.

30. A valve assembly comprising:
a cylinder having a plurality of ports provided in a lateral surface thereof, the cylinder having at least one first flow path configured to connect a first pair of ports among the plurality of ports and opened in a first axial direction, and at least one second flow path configured to connect a second pair of ports among the plurality of ports and opened in a second axial direction;
a first plate coupled to the cylinder in the first axial direction and configured to close the at least one first flow path; and
a second plate coupled to the cylinder in the second axial direction and configured to close the at least one second flow path, wherein the plurality of ports is aligned at a same height of the cylinder.
